(19) United States
(12) Patent Application Publication
(10) Pub. No.: US 2026/0210262 A1
(43) Pub. Date: Jul. 23, 2026

(54) RING SEGMENT FOR GAS TURBINE ENGINE

(71) Applicant: Siemens Energy Global GmbH & Co., KG, München (DE)

(72) Inventors: Atin Sharma, Pennington, NJ (US); Jesus Velez-Quinones, Jupiter, FL (US); Keith L. Boeck, Palm Beach Gardens, FL (US)

(21) Appl. No.: 19/157,836

(22) PCT Filed: Feb. 15, 2024
(86) PCT No.: PCT/US2024/015895

§ 371 Date: Aug. 19, 2025

Related U.S. Application Data
(60) Provisional application No. 63/451,098, filed on Mar. 9, 2023.

(51) Int. Cl. F01D 25/24

(52) U.S. Cl. CPC F01D 25/24; F05D 2220/32

(57) ABSTRACT

A ring segment is arranged to define a gap with a rotating turbine blade. The ring segment includes a substrate and a coating fixedly attached to the substrate. The coating defines a base surface. A ridge is formed as a part of the coating and extends from the base surface away from the substrate to a first surface. The ridge has a first side surface and a second side surface. The first surface extends between the first side surface and the second side surface and partially defining the gap. A first notch is formed on the first side surface at a first location and extends toward the second side surface.

### BACKGROUND

A gas turbine engine typically includes a compressor section, a turbine section, and a combustion section disposed therebetween. The compressor section includes multiple stages of rotating compressor blades and stationary compressor vanes. The combustion section typically includes a plurality of combustors. The combustors may include fuel injectors for providing a fuel to be mixed with compressed air from the compressor section and an ignition source for igniting the mixture to form hot exhaust gas for the turbine section. The turbine section includes multiple stages of rotating turbine blades and stationary turbine vanes. The rotating turbine blades and stationary turbine vanes often operate in a high temperature environment and are internally cooled.

The turbine section also includes a plurality of ring segments. Each of the plurality of ring segments cooperates with a respective rotating turbine blade to define a gap therebetween. During operation of the gas turbine engine, a tight gap is desired to achieve a desired performance of the gas turbine engine.

### BRIEF SUMMARY

In one aspect, a ring segment arranged to define a gap with a rotating turbine blade, the ring segment includes a substrate, a coating fixedly attached to the substrate, the coating defining a base surface, a ridge formed as a part of the coating and extending from the base surface away from the substrate to a first surface, the ridge having a first side surface and a second side surface, the first surface extending between the first side surface and the second side surface and partially defining the gap, and a first notch formed on the first side surface at a first location and extending toward the second side surface.

In one aspect, a ring segment arranged to define a gap with a rotating turbine blade, the ring segment includes a substrate, a coating fixedly attached to the substrate, the coating defining a base surface, a groove formed on the coating, the groove having a first side surface that extends from the base surface to a first surface and a second side surface that extends from the base surface to a second surface, the first surface and the second surface cooperating with the rotating turbine blade to define the gap, and a first notch formed on the first side surface at a first location and extending away from the second side surface.

### BRIEF DESCRIPTION OF THE DRAWINGS

To easily identify the discussion of any particular element or act, the most significant digit or digits in a reference number refer to the figure number in which that element is first introduced.

FIG. 1 is a longitudinal cross-sectional view of a gas turbine engine taken along a plane that contains a longitudinal axis or central axis.

FIG. 2 is a perspective view of a ring segment suitable for use in the gas turbine engine of FIG. 1.

FIG. 3 is a perspective view of a portion of the ring segment of FIG. 2.

FIG. 4 is a section view of a portion of the ring segment of FIG. 2 including a ridge having a first arrangement.

FIG. 5 is a section view of a portion of the ring segment of FIG. 2 including a ridge having a second arrangement.

FIG. 6 is a section view of a portion of the ring segment of FIG. 2 including a ridge having a third arrangement.

FIG. 7 is a section view of a portion of the ring segment of FIG. 2 including a ridge having a fourth arrangement.

### DETAILED DESCRIPTION

Before any embodiments of the invention are explained in detail, it is to be understood that the invention is not limited in its application to the details of construction and the arrangement of components set forth in this description or illustrated in the following drawings. The invention is capable of other embodiments and of being practiced or of being carried out in various ways. Also, it is to be understood that the phraseology and terminology used herein is for the purpose of description and should not be regarded as limiting.

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

It should be understood that the words or phrases used herein should be construed broadly, unless expressly limited in some examples. For example, the terms “including”, “having”, and “comprising”, as well as derivatives thereof, mean inclusion without limitation. The singular forms “a”, “an”, and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Furthermore, while multiple embodiments or constructions may be described herein, any features, methods, steps, components, etc. described with regard to one embodiment are equally applicable to other embodiments absent a specific statement to the contrary.

Terms such as “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In the description, the terms “axial” or “axially” refer to a direction along a longitudinal axis of a gas turbine engine. The terms “radial” or “radially” refer to a direction perpendicular to the longitudinal axis of the gas turbine engine. The terms “downstream” or “aft” refer to a direction along a flow direction. The terms “upstream” or “forward” refer to a direction against the flow direction.

In addition, the term “adjacent to” may mean that an element is relatively near to but not in contact with a further element or that the element is in contact with the further portion, unless the context clearly indicates otherwise. Further, the phrase “based on” is intended to mean “based, at least in part, on” unless explicitly stated otherwise.

Terms “about” or “substantially” or like terms are intended to cover variations in a value that are within normal industry manufacturing tolerances for that dimension. If no industry standard is available, a variation of twenty percent would fall within the meaning of these terms unless otherwise stated.

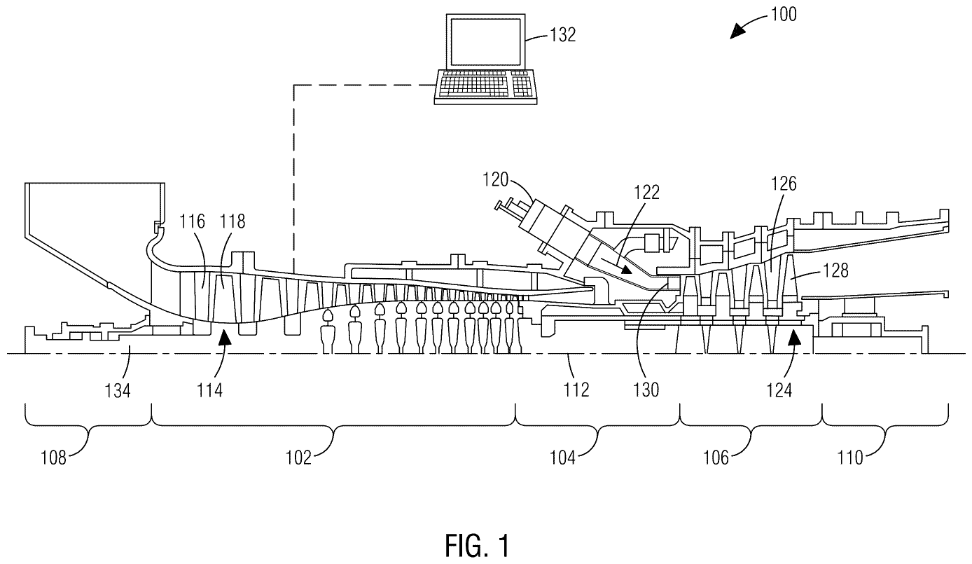

FIG. 1 illustrates an example of a gas turbine engine 100 including a compressor section 102, a combustion section 104, and a turbine section 106 arranged along a central axis 112. The compressor section 102 includes a plurality of compressor stages 114 with each compressor stage 114 including a set of stationary compressor vanes 116 or adjustable guide vanes and a set of rotating compressor blades 118. A rotor 134 supports the rotating compressor blades 118 for rotation about the central axis 112 during operation. In some constructions, a single one-piece rotor 134 extends the length of the gas turbine engine 100 and is supported for rotation by a bearing at either end. In other constructions, the rotor 134 is assembled from several separate spools that are attached to one another or may include multiple disk sections that are attached via a bolt or plurality of bolts.

The compressor section 102 is in fluid communication with an inlet section 108 to allow the gas turbine engine 100 to draw atmospheric air into the compressor section 102. During operation of the gas turbine engine 100, the compressor section 102 draws in atmospheric air and compresses that air for delivery to the combustion section 104. The illustrated compressor section 102 is an example of one compressor section 102 with other arrangements and designs being possible.

In the illustrated construction, the combustion section 104 includes a plurality of separate combustors 120 that each operate to mix a flow of fuel with the compressed air from the compressor section 102 and to combust that air-fuel mixture to produce a flow of high temperature, high pressure combustion gases or exhaust gas 122. Of course, many other arrangements of the combustion section 104 are possible.

The turbine section 106 includes a plurality of turbine stages 124 with each turbine stage 124 including a number of stationary turbine vanes 126 and a number of rotating turbine blades 128. The turbine stages 124 are arranged to receive the exhaust gas 122 from the combustion section 104 at a turbine inlet 130 and expand that gas to convert thermal and pressure energy into rotating or mechanical work. The turbine section 106 is connected to the compressor section 102 to drive the compressor section 102. For gas turbine engines 100 used for power generation or as prime movers, the turbine section 106 is also connected to a generator, pump, or other device to be driven. As with the compressor section 102, other designs and arrangements of the turbine section 106 are possible.

An exhaust portion 110 is positioned downstream of the turbine section 106 and is arranged to receive the expanded flow of exhaust gas 122 from the final turbine stage 124 in the turbine section 106. The exhaust portion 110 is arranged to efficiently direct the exhaust gas 122 away from the turbine section 106 to assure efficient operation of the turbine section 106. Many variations and design differences are possible in the exhaust portion 110. As such, the illustrated exhaust portion 110 is but one example of those variations.

A control system 132 is coupled to the gas turbine engine 100 and operates to monitor various operating parameters and to control various operations of the gas turbine engine 100. In preferred constructions the control system 132 is typically micro-processor based and includes memory devices and data storage devices for collecting, analyzing, and storing data. In addition, the control system 132 provides output data to various devices including monitors, printers, indicators, and the like that allow users to interface with the control system 132 to provide inputs or adjustments. In the example of a power generation system, a user may input a power output set point and the control system 132 may adjust the various control inputs to achieve that power output in an efficient manner.

The control system 132 can control various operating parameters including, but not limited to variable inlet guide vane positions, fuel flow rates and pressures, engine speed, valve positions, generator load, and generator excitation. Of course, other applications may have fewer or more controllable devices. The control system 132 also monitors various parameters to assure that the gas turbine engine 100 is operating properly. Some parameters that are monitored may include inlet air temperature, compressor outlet temperature and pressure, combustor outlet temperature, fuel flow rate, generator power output, bearing temperature, and the like. Many of these measurements are displayed for the user and are logged for later review should such a review be necessary.

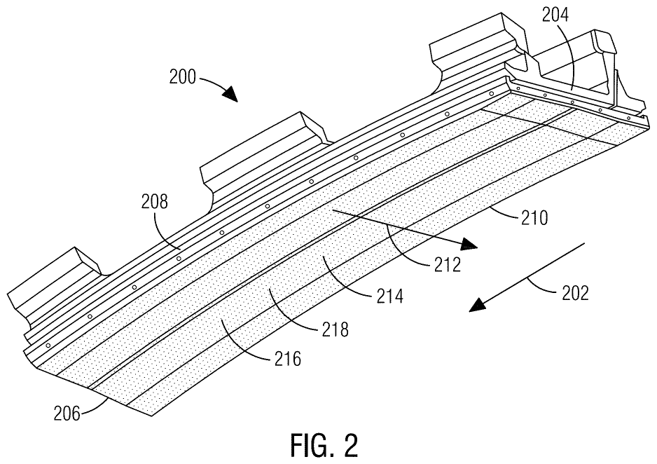

FIG. 2 illustrates a perspective view of a ring segment 200 that is suitable for use in the gas turbine engine 100 of FIG. 1. The ring segment 200 is disposed adjacent the rotating turbine blade 128. The ring segment 200 is one of a plurality of ring segments 200 that are arranged circumferentially with respect to the central axis 112.

The ring segment 200 has a forward mate face 204 with respect to the rotation direction 202 and an aft mate face 206 opposite to the forward mate face 204. The forward mate face 204 of one ring segment 200 faces the aft mate face 206 of an adjacent ring segment 200. The working fluid includes the exhaust gas 122 shown in FIG. 1.

A substrate 214 extends between the forward mate face 204 and the aft mate face 206 and between the upstream side face 208 and the downstream side face 210. An axial length of the substrate 214 is defined between the upstream side face 208 and the downstream side face 210.

A coating 216 is fixedly attached to the substrate 214 defining a base surface 218 on the substrate 214. In other constructions, the coating 216 may be fixedly attached to other locations as needed by a performance requirement of the gas turbine engine 100, such as the forward mate face 204, the aft mate face 206, the upstream side face 208, etc. The coating 216 forms a part of the ring segment 200.

The coating 216 includes a dense ceramic coating. The coating 216 may include multiple layers, such as a layer of bond coating interfacing with the substrate 214, a layer or multiple layers of thermal barrier coating on the bond coating, and/or a layer of abradable coating. The coating 216 may be made with a high fracture toughness material to improve its strength and toughness. The high fracture toughness material may include Yttria Partially Stabilized Zirconia, etc. A porosity of the coating 216 may be less than 10%, or less than 8%, or less than 5%. The low porosity results in the higher fracture toughness.

The porosity is the percentage of void space in a volume of the coating 216. It is defined as the ratio of the volume of the voids or pore space divided by the total volume of the coating 216. In some constructions, the coating 216 may include surface engineering, such as machined grooves, that affectively increases the porosity in the volume that contains the surface engineering.

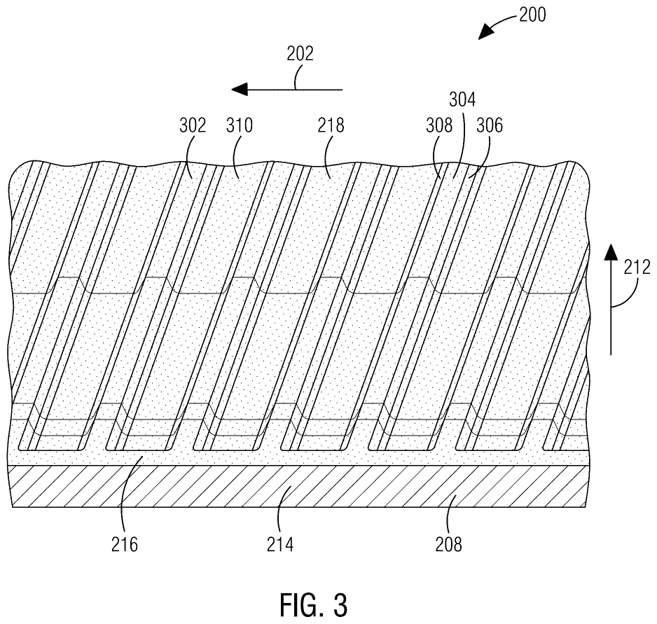

FIG. 3 illustrates a perspective view of a portion of the ring segment 200. A plurality of ridges 302, with an associated plurality of grooves 310, are formed from the coating 216. Each ridge 302 extends from the base surface 218 of the coating 216 away from the substrate 214 to a first surface 304. The ridge 302 has a first side surface 306 and a second side surface 308. The first surface 304 extends between the first side surface 306 and the second side surface 308.

The ridge 302 extends between the upstream side face 208 and the downstream side face 210 defining a length of the ridge 302. The ridge 302 has a width that is defined as the shortest distance between the first side surface 306 and the second side surface 308 in a plane parallel to the base surface 218. The ridge 302 may be linear, curved, combination of different angled linear segments, combination of linear and curved, or any other combinations along the length.

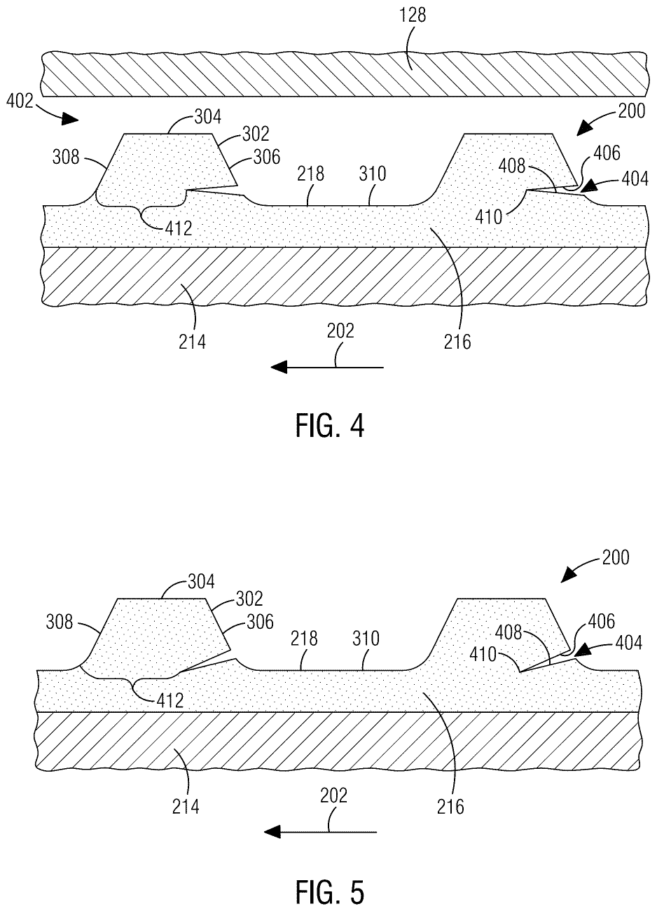

FIG. 4 illustrates a section view of a portion of the ring segment 200 including the ridge 302 in a first arrangement. A schematic portion of the rotating turbine blade 128 is also shown in FIG. 4. The ring segment 200 is disposed adjacent to the rotating turbine blade 128 defining a gap 402 therebetween. The first surface 304 of the ridge 302 faces the rotating turbine blade 128. The length of the ridge 302 covers a tip path of the rotating turbine blade 128.

The ridge 302 has a trapezoidal cross section in which the first side surface 306 and the second side surface 308 extend from the base surface 218 toward each other. In other constructions, the first side surface 306 and the second side surface 308 may be parallel to each other forming a square or rectangular cross section.

A notch 404 is formed in the ridge 302. The notch 404 is formed on one of the first side surface 306 and the second side surface 308 and extends toward the opposite side surface. In the arrangement shown in FIG. 4, the notch 404 is formed on the first side surface 306 and extends toward the second side surface 308. The first side surface 306 is a leading side surface with respect to the rotation direction 202. In other arrangement, the first side surface 306 may be a trailing side surface with respect to the rotation direction 202. The notch 404 is formed at a location on the first side surface 306 that is closer to the base surface 218 than to the first surface 304. In one embodiment, the notch 404 may be formed at the base surface 218.

The notch 404 has a wedge shape formed by a first notch side 406 and a second notch side 408. The first notch side 406 and the second notch side 408 extend from the first side surface 306 and meet together at a notch tip 410. The notch tip 410 does not necessarily include a sharp tip but rather may include a flat bottom or a rounded or semi-circular bottom as may be formed by the manufacturing process selected to form the notch 404. Each of the first notch side 406 and the second notch side 408 extends at an angle with respect to the base surface 218. In the embodiment shown in FIG. 4, the angle of the first notch side 406 and the angle of the second notch side 408 is between zero to ten degrees with respect to the base surface 218. The geometry and orientation of the notch 404 may be suitable selected to meet desired performance.

The notch 404 extends along an entire length of the ridge 302. In other arrangements, the notch 404 may be interrupted to form a plurality of notch segments along the length of the ridge 302. The notch 404 has a depth that is defined from the first side surface 306 to the notch tip 410. The depth is between 0.01 mm and less than the width of the ridge 302 at the base surface 218. A neck 412 is formed between the notch tip 410 and the second side surface 308. An opening of the notch 404 is between 0.01 mm to 1 mm.

Other dimensions of the opening are possible to meet desired design requirements of the gas turbine engine 100.

The notch 404 may be created by a manufacturing method, such as conventional milling, water-jet milling, laser machining, or additive manufacture, etc.

FIG. 5 illustrates a section view of a portion of the ring segment 200 including the ridge 302 in a second arrangement. In the arrangement shown in FIG. 5, the angle of the first notch side 406 and the angle of the second notch side 408 is greater than ten degrees with respect to the base surface 218. The geometry and orientation of the notch 404 may be suitable selected to meet desired performance.

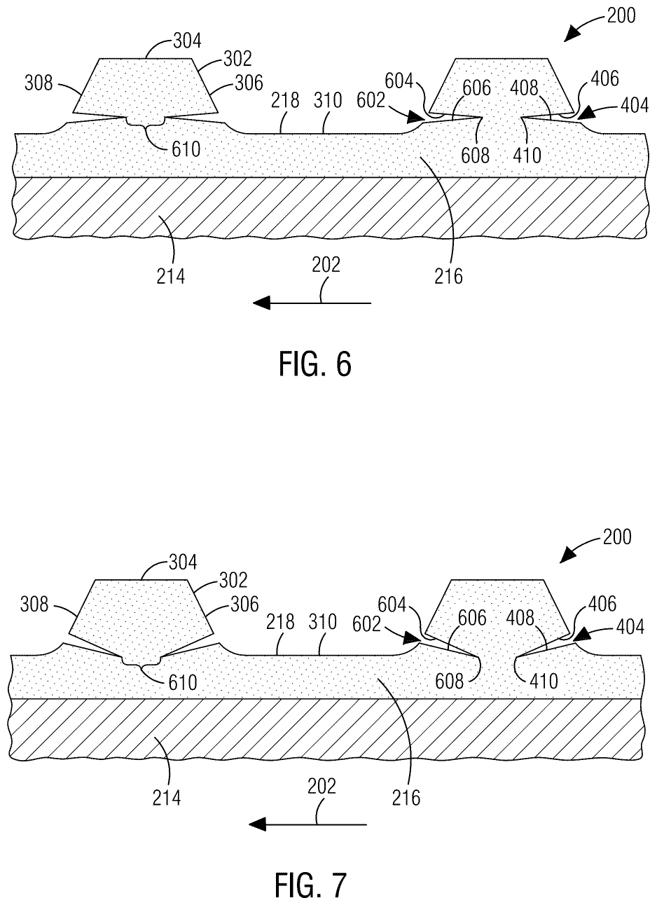

FIG. 6 illustrates a section view of a portion of the ring segment 200 including the ridge 302 in a third arrangement. In the arrangement shown in FIG. 6, the notch 404 is a first notch 404 that is formed on the first side surface 306 and extends toward the second side surface 308. The first notch 404 is formed at a first location on the first side surface 306 that is closer to the base surface 218 than to the first surface 304. In one embodiment, the first notch 404 may be formed at the base surface 218. The first notch 404 has a first depth between the first side surface 306 and a first notch tip 410.

A second notch 602 is formed on the second side surface 308 and extends toward the first side surface 306. The second notch 602 is formed at a second location on the second side surface 308 that is closer to the base surface 218 than to the first surface 304. In one embodiment, the second notch 602 may be formed at the base surface 218.

The second notch 602 has a wedge shape formed by a third notch side 604 and a fourth notch side 606. The third notch side 604 and the fourth notch side 606 extend from the second side surface 308 and meet together at a second notch tip 608. The second notch tip 608 does not necessarily include a sharp tip but rather may include a flat bottom or a rounded or semi-circular bottom as may be formed by the manufacturing process selected to form the second notch 602. Each of the third notch side 604 and the fourth notch side 606 extends at an angle with respect to the base surface 218. In the embodiment shown in FIG. 6, the angle of the third notch side 604 and the angle of the fourth notch side 606 is between zero to ten degrees with respect to the base surface 218. The geometry and orientation of the second notch 602 may be suitable selected to meet a desired performance.

The second notch 602 extends along an entire length of the ridge 302. The second notch 602 has a second depth between the second side surface 308 and a second notch tip 608. The sum of the depth of the first notch 404 and the depth of the second notch 602 is less than the width of the ridge 302. A neck 610 is formed between the first notch tip 410 and the second notch tip 608. An opening of the second notch 602 is between 0.01 mm to 1 mm. Other dimensions of the opening are possible to meet desired design requirements of the gas turbine engine 100.

The second notch 602 may be created by a manufacturing method, such as conventional milling, water-jet milling, laser machining, or additive manufacture, etc.

In the arrangement illustrated in FIG. 6, the first notch 404 is symmetric to the second notch 602. In other arrangements, the first notch 404 may be different from the second notch 602, such as having different geometries, and/or located at different locations on the first side surface 306 and the second side surface 308, and/or having different angles of notch sides with respect to the base surface 218, etc.

FIG. 7 illustrates a section view of a portion of the ring segment 200 including the ridge 302 having a fourth arrangement. In the arrangement shown in FIG. 7, the first notch 404 extends from the first side surface 306 toward the base surface 218. The second notch 602 extends from the second side surface 308 toward the base surface 218. The angle of the first notch side 406 and the angle of the second notch side 408 of the first notch 404 are greater than 10 degrees with respect to the base surface 218. The angle of the third notch side 604 and the fourth notch side 606 of the notch 602 are greater than 10 degrees with respect to the base surface 218.

In the arrangement illustrated in FIG. 7, the first notch 404 is symmetric to the second notch 602. In other arrangements, the first notch 404 may be different from the second notch 602, such as having different geometries, and/or located at different locations on the first side surface 306 and the second side surface 308, and/or having different angles of notch sides with respect to the base surface 218, etc.

During operation of the gas turbine engine 100, a tight running gap 402 is desired to achieve designed performance of the gas turbine engine 100. However, rub interaction between the rotating turbine blade 128 and the ring segment 200 may occur during the operation, which may wear the rotating turbine blade 128 and the ring segment 200. The resultant wear of the rotating turbine blade 128 and the ring segment 200 may increase the gap 402 and render a loss of sealing which may impact the performance of the gas turbine engine 100. The notch 404 works as a stress riser, thereby guiding and controlling a location of a fracture in operation. A neck of the ridge 302 without the notch 404 is defined between the first side surface 306 and the second side surface 308 at the base surface 218.

The notch 404 of the ridge 302 reduces a size of the neck 412 compared to a size of the neck without the notch 404. The reduced size of the neck 412 reduces a load that is required to fracture the ridge 302 at the location of the notch 404. The ridge 302 having the notch 404 also reduces undesired spallation of the coating 216 and controls a location of the spallation of the coating 216 during the rub interaction between the rotating turbine blade 128 and the ring segment 200. Thus, the coating 216 can work as designed and thus improves parts life of the gas turbine engine 100.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

### LISTING OF DRAWING ELEMENTS

100 gas turbine engine
102 compressor section
104 combustion section
106 turbine section
108 inlet section
110 exhaust portion
112 central axis
114 compressor stage
116 stationary compressor vane
118 rotating compressor blade
120 combustor
122 exhaust gas
124 turbine stage
126 stationary turbine vane
128 rotating turbine blade
130 turbine inlet
132 control system
134 rotor
200 ring segment
202 rotation direction
204 forward mate face
206 aft mate face
208 upstream side face
210 downstream side face
212 working fluid direction
214 substrate
216 coating
218 base surface
302 ridge
304 first surface
306 first side surface
308 second side surface
310 groove
402 gap
404 notch
406 first notch side
408 second notch side
410 notch tip
412 neck
602 notch
604 third notch side
606 fourth notch side
608 notch tip
610 neck

What is claimed is:

1. A ring segment arranged to define a gap with a rotating turbine blade, the ring segment comprising:
a substrate;
a coating fixedly attached to the substrate, the coating defining a base surface;
a ridge formed as a part of the coating and extending from the base surface away from the substrate to a first surface, the ridge having a first side surface and a second side surface, the first surface extending between the first side surface and the second side surface and partially defining the gap; and
a first notch formed on the first side surface at a first location and extending toward the second side surface.

2. The ring segment of claim 1, wherein the first location is closer to the base surface than the first surface.

3. The ring segment of claim 1, wherein the ridge extends along a length, and wherein the first notch extends along an entire length of the ridge.

4. The ring segment of claim 1, wherein the notch extends from the first side surface to a tip defining a depth of the notch, and wherein the depth is between 0.01 mm and a width of the ridge at the base surface.

5. The ring segment of claim 1, wherein the notch has a wedge shape formed by a first notch side and a second notch side, and wherein each of the first notch side and the second notch side is arranged at an oblique angle with respect to the base surface.

6. The ring segment of claim 1, wherein the first side surface is a leading side with respect to a rotation direction of the rotating turbine blade.

7. The ring segment of claim 6, further comprising a second notch formed on the second side surface at a second location and extending toward the first side surface.

8. The ring segment of claim 7, wherein the second location is closer to the base surface than the first surface.

9. The ring segment of claim 7, wherein the second notch is symmetric to the first notch.

10. The ring segment of claim 1, wherein an opening of the notch is between 0.01 mm to 1 mm.

11. A ring segment arranged to define a gap with a rotating turbine blade, the ring segment comprising:
a substrate;
a coating fixedly attached to the substrate, the coating defining a base surface;
a groove formed on the coating, the groove having a first side surface that extends from the base surface to a first surface and a second side surface that extends from the base surface to a second surface, the first surface and the second surface cooperating with the rotating turbine blade to define the gap; and
a first notch formed on the first side surface at a first location and extending away from the second side surface.

12. The ring segment of claim 11, wherein the first location is closer to the base surface than the first surface.

13. The ring segment of claim 11, wherein the groove extends along a length, and wherein the first notch extends along an entire length of the groove.

14. The ring segment of claim 11, wherein the groove is one of a plurality of grooves, wherein a ridge is defined between two adjacent grooves, wherein the notch extends from the first side surface to a tip defining a depth of the notch, and wherein the depth is between 0.01 mm and a width of the ridge at the base surface.

15. The ring segment of claim 11, wherein the first notch has a wedge shape formed by a first notch side and a second notch side, wherein each of the first notch side and the second notch side are arranged at an oblique angle with respect to the base surface.

16. The ring segment of claim 11, wherein the first side surface is a trailing side with respect to a rotation direction of the rotating turbine blade.

17. The ring segment of claim 16, further comprising a second notch formed on the second side surface at a second location and extending away from the first side surface.

18. The ring segment of claim 17, wherein the second location is closer to the base surface than the second surface.

19. The ring segment of claim 11, wherein the second notch is symmetric to the first notch.

20. The ring segment of claim 11, wherein an opening of the notch is between 0.01 mm to 1 mm.
